(19) United States
(12) Patent Application Publication
(10) Pub. No.: US 2010/0084849 A1
(43) Pub. Date: Apr. 8, 2010

(54) System and Method for Linking Digital and Printed Contents Using Unique Content Identifiers

(75) Inventor: Ryuji Masuda, Los Angeles, CA (US)

Correspondence Address: WHITE & CASE LLP;PATENT DEPARTMENT, 1155 AVENUE OF THE AMERICAS, NEW YORK, NY, 10036, US

(73) Assignee: CASDEX, INC., Camarillo, CA (US)

(21) Appl. No.: 12/244,572

(22) Filed: Oct. 2, 2008

(51) Int. Cl. B42D 15/00; G06F 7/06; G06F 17/30

(52) U.S. Cl. 283/67; 707/E17.014

(57) ABSTRACT

One embodiment of a method for linking digital and printed contents includes receiving a request to retrieve a data element identified by a content identifier, identifying a storage location associated with the content identifier, retrieving a data element stored at the storage location, calculating a second content identifier of the retrieved data element, comparing the content identifier and the second content identifier, if the content identifier and the second content identifier match, creating a watermark derived from the content identifier, and creating an image of the retrieved data element that includes the watermark The watermark may be an alphanumeric string derived from the content identifier or a graphic representation, such as a barcode, derived from the content identifier. The watermark links the electronically stored contents with a printed copy of the watermarked image.

### FIELD OF THE INVENTION

This invention relates generally to content addressable storage and relates more particularly to a system and method for linking digital and printed contents using unique content identifiers.

### BACKGROUND

Content addressable storage (CAS) is a technique for storing a segment of electronic information that can be retrieved based on its content, not on its storage location. When information is stored in a CAS system, a content identifier is created and linked to the information. The content identifier is then used to retrieve the information. The content identifier is stored with an identifier of where the information is stored. When information is to be stored, a cryptographic algorithm, such as a hashing algorithm, is used to create the content identifier that is ideally unique to the information. The content identifier is then compared to a list of content identifiers for information already stored on the system. If the content identifier is found on the list, the information is not stored a second time. Thus a typical CAS system does not store duplicates of information, providing efficient storage. If the content identifier is not already on the list, the information is stored, and the content identifier is stored in the table with the location of the information.

Content addressable storage is most commonly used to store information that does not change, such as archived emails, financial records, medical records, and publications. Content addressable storage is highly suited to storing information required by compliance programs because the content can be verified as not having changed. Content addressable storage is also highly suited for storing documents that may need to be produced in litigation discovery. A document that can be produced with a content identifier that was created using a reliable hashing algorithm can establish the authenticity of the document. When information is retrieved from a CAS system, a content identifier is provided, and the location corresponding to that content identifier is looked up and the information is retrieved. The content identifier is then recalculated based on the content of the retrieved information and the newly-calculated content identifier is compared to the provided content identifier to verify that the content has not changed.

But all of the verification and authentication done by a typical CAS system occurs in the background. Most CAS systems are behind many network layers and the operation of the CAS system is transparent to the user. A user must take it on faith that the document or other information being retrieved is indeed the information that was originally stored. This is a problem in a compliance or litigation discovery situation where it can be critical to be able to show that the retrieved information has not been modified.

This problem of verifying that retrieved information is indeed the information that was stored is compounded when the information is printed. A document printed from a CAS system may not have any indicators on its face that would one to verify that the printed document is identical to the stored content. But this may be an issue is situations when it is critical that a printed document match an electronic one. For example, in negotiating contracts and other agreements, drafts are typically exchanged electronically. When finalizing and signing such agreements, it is crucial that the final printed, signed document matches the negotiated final electronic file. In another example, in a litigation where documents to be submitted as evidence need to be authenticated, a person may not be available to testify as to the authenticity of a printout of an electronic file.

### SUMMARY

One embodiment of a method for linking digital and printed contents includes receiving a request to retrieve a data element identified by a content identifier, identifying a storage location associated with the content identifier, retrieving a data element stored at the storage location, calculating a second content identifier of the retrieved data element, comparing the content identifier and the second content identifier, if the content identifier and the second content identifier match, creating a watermark derived from the content identifier, and creating an image of the retrieved data element that includes the watermark The watermark may be an alphanumeric string derived from the content identifier or a graphic representation, such as a barcode, derived from the content identifier. The watermark links the electronically stored contents with a printed copy of the watermarked image.

One embodiment of a system for linking digital and printed contents includes a content addressable storage manager configured to control the storing and retrieving of data elements to a content storage, the content addressable storage manager including a content identifier generator configured to produce a content identifier for each data element stored in the content storage, a content addressable storage application coupled to the content addressable storage manager and configured to receive a retrieved data element and a stored content identifier for the retrieved data element from the content addressable storage manager, and configured to create a watermark derived from the stored content identifier and to create an image document of the data element that includes the watermark to produce a watermarked image, and a content addressable storage interface configured to communicate with the content addressable storage application and to receive the watermarked image from the content addressable storage application. The content addressable storage interface is further configured to enable the watermarked image to be printed.

### BRIEF DESCRIPTION OF THE DRAWINGS

FIG. 1 is a block diagram of one embodiment of a system including a content addressable storage system, in accordance with the present invention;

FIG. 2 is a flowchart of method steps for storing a data element into the content addressable storage system of FIG. 1, according to one embodiment of the invention;

FIG. 3 is a flowchart of method steps for retrieving a watermarked image of a data element from the content addressable storage system of FIG. 1, according to one embodiment of the invention;

FIG. 4 is a diagram of one embodiment of a graphical user interface displaying a watermarked image of a data element, in accordance with the invention; and

FIG. 5 is a diagram of another embodiment of a graphical user interface displaying a watermarked image of a data element, in accordance with the invention.

### DETAILED DESCRIPTION

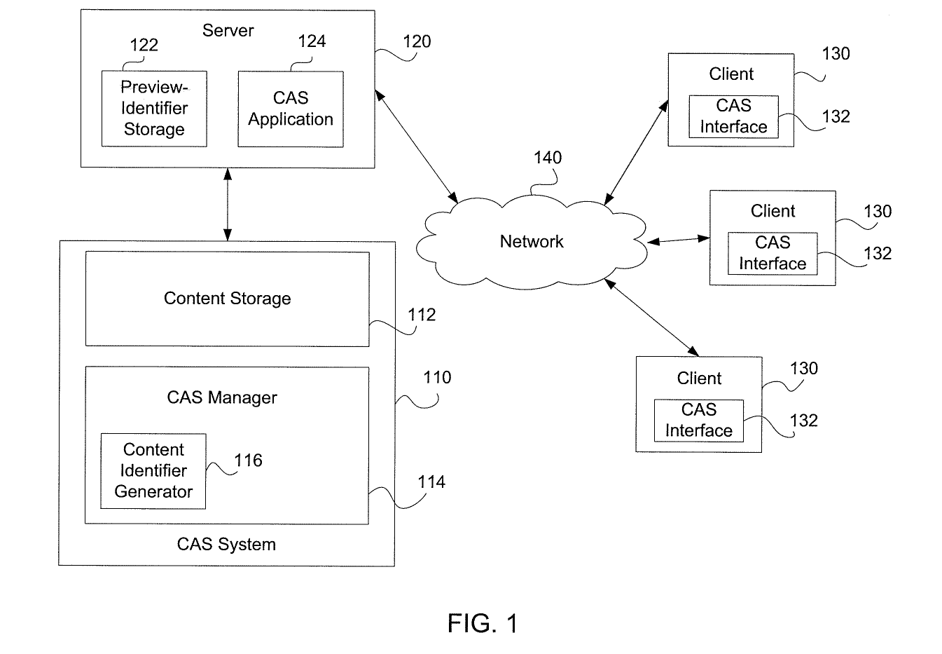

FIG. 1 is a block diagram of one embodiment of a system including, but not limited to, a content addressable storage (CAS) system 110, a server 120, a network 140, and a plurality of clients 130. CAS system 110 includes content storage 112 and a CAS manager 114. Content storage 112 may store data elements of any type, including documents, images, video files, audio files, and emails. Large files may be divided into more than one data element that are stored separately. Content storage 112 is preferably embodied as an array of magnetic disks, but can also be embodied as optical disks, tape, or a combination of magnetic disks, optical disks, and tapes. CAS manager 114 controls the writing of data elements to content storage 112 and controls the reading of data elements from content storage 112. Before writing a data element to content storage 112, CAS manager 114 creates a content identifier for that data element using content identifier generator 116. Content identifier generator 116 applies a hashing algorithm to the content of the data element to generate a unique content identifier for the data element. Content identifier generator 116 also applies the hashing algorithm to metadata associated with the data element to generate a metadata identifier. In one embodiment, the hashing algorithm is the well-known MD5 cryptographic hash algorithm that produces a 128-bit number derived from the content of a data element; however any other hashing algorithm may be used to generate content identifiers so long as the probability of generating identical content identifiers for different data elements using that algorithm is below an acceptable threshold.

Clients 130 communicate with server 120 via network 140 to store and retrieve content from CAS system 110. Client 130 may be any general computing device such as a personal computer, a workstation, a laptop computer, or a handheld computer. Client 130 includes a CAS interface 132 that is configured to enable a user of client 130 to store content in CAS system 110 and to retrieve content from CAS system 110. CAS interface 132 includes a graphical user interface (GUI) that provides information to a user and enables the user to provide inputs to CAS interface 132. Network 140 may be any type of communication network such as a local area network or a wide area network, and may be wired, wireless, or a combination.

Server 120 includes a CAS application 124 that is configured to communicate with clients 130 and CAS system 110. In one embodiment, CAS application 124 is configured to communicate with clients 130 using a standard communication protocol such as a TCP/IP protocol, and is configured to communicate with CAS system 110 using a storage network protocol such as, for example, Fibre Channel. Server 120 also includes a preview-identifier storage 122 that stores previews of data elements stored in CAS system 110, content identifiers and metadata identifiers associated with the previews, and storage location identifiers associated with the previews. In one embodiment, a preview is a “thumbnail” image of a data element; however other types of previews are within the scope of the invention.

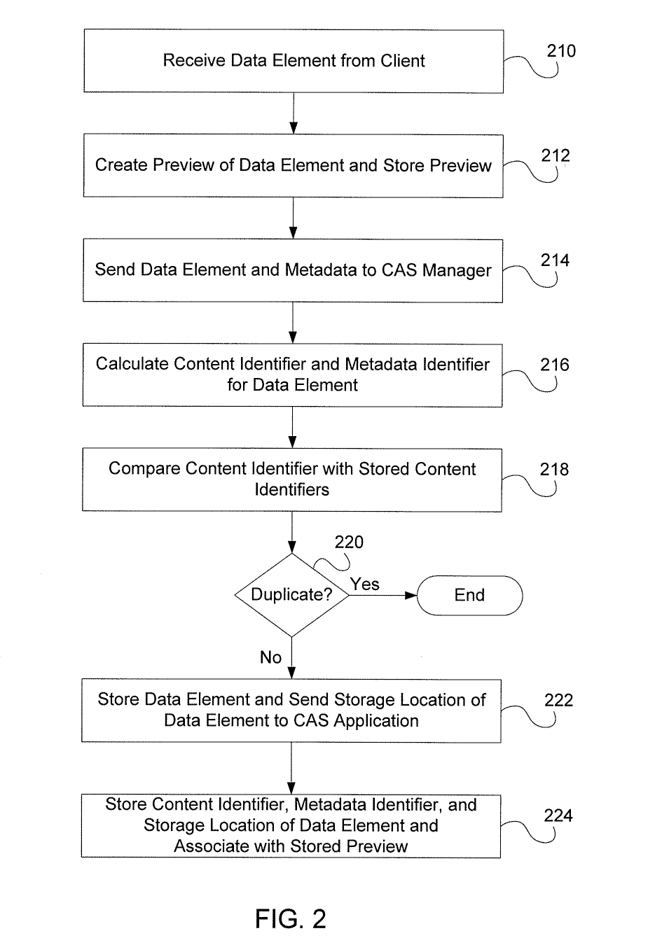

FIG. 2 is a flowchart of method steps for storing a data element into the content addressable storage system of FIG. 1, according to one embodiment of the invention. In step 210, CAS application 124 receives a data element from client 130. A user of client 130 selects a data element and indicates via CAS interface 132 that the data element is to be stored in CAS system 112. In step 212, CAS application 124 creates a preview of the data element and stores the preview in preview-identifier storage 122. In step 214, CAS application 124 sends the data element and metadata associated with the data element to CAS manager 114. The metadata may include a filename, filepath, filesize, author, and/or date. In step 216, content identifier generator 116 calculates a content identifier for the data element using a hashing algorithm and calculates a metadata identifier for the metadata associated with the data element. In step 218, CAS manager 114 sends the content identifier of the data element and the metadata identifier to CAS application 124, which compares the content identifier with the content identifiers stored in preview-identifier storage 122 to determine if a duplicate of the data element has been previously stored in CAS system 110. In step 220, if the content identifier is not a duplicate, the method continues with step 222, in which CAS manager 114 writes the data element to content storage 112 and sends the storage location identifier to CAS application 124. Then in step 224, CAS application 124 stores the content identifier, metadata identifier, and storage location identifier of the data element in preview-identifier storage 112 and associates the content identifier, metadata identifier and storage location identifier with the preview of the data element in preview-identifier storage 112. In one embodiment, preview-identifier storage 112 includes a table that reflects the relationships between a preview of a data element, the content identifier and metadata identifier of that data element, and the storage location of that data element in content storage 112. Returning to step 220, if the content identifier is a duplicate, the method ends because the data element has been previously stored in content storage 112.

The data element to be stored may be a revised version of a data element that has been stored in CAS system 110. For each data element to be stored, CAS application 124 queries preview-identifier storage 122 to determine if a data element with the same filename as the current data element has been previously stored in CAS system 110. If there is only one other data element with that filename stored, CAS application 124 creates an archive that includes the previews, content identifiers, and metadata identifiers of both data elements and will store the previews, content identifiers, and metadata identifiers of all future versions (each a separate data element) for that filename in the archive. If an archive having that filename already exists, CAS application 124 will add the preview, content identifier, and metadata identifier of the data element to the archive.

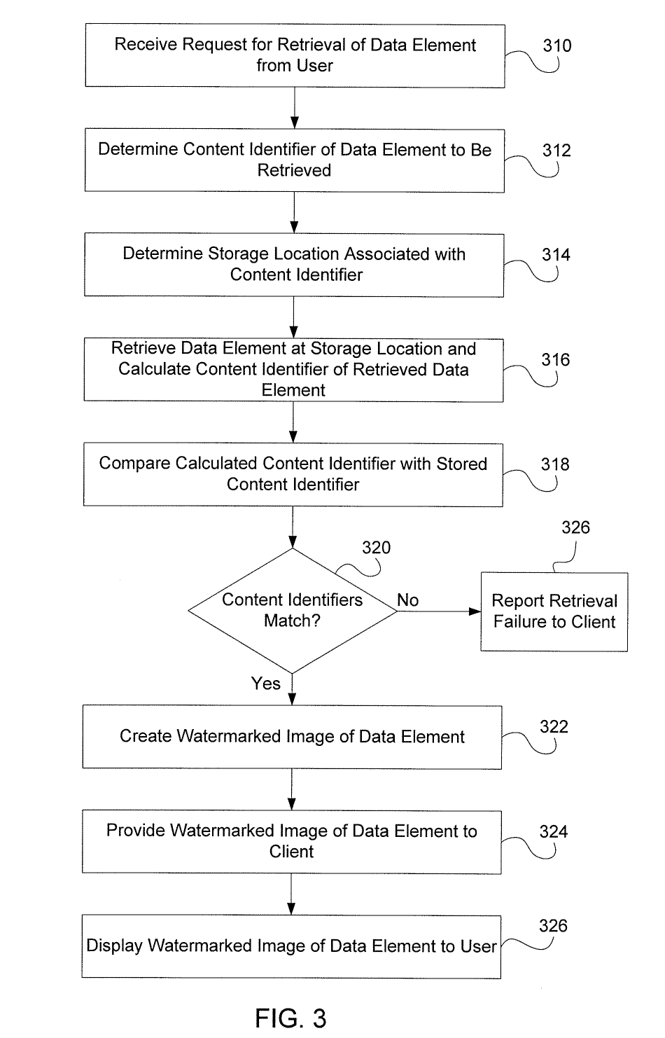

FIG. 3 is a flowchart of method steps for retrieving a watermarked image of a data element from the content addressable storage system of FIG. 1, according to one embodiment of the invention. In step 310, CAS application 124 receives a request from a user for retrieval of a data element via CAS interface 132. In one embodiment, CAS application 124 provides a listing of data elements stored in content storage 112 to CAS interface 132, where the listing identifies the data elements by filename or other metadata. A user then provides input to CAS interface 132 to identify the data element to be retrieved, such as by clicking on a filename displayed by a GUI, and CAS interface 132 sends the selected filename to CAS application 124. In step 312, CAS application 124 determines the content identifier of the data element to be retrieved. In one embodiment, CAS application 124 queries preview-identifier storage 122 for the content identifier that is associated with the filename or other metadata provided by CAS interface 132. In step 314, CAS application 124 determines the storage location associated with the content identifier and provides the storage location to CAS manager 114. In step 316, CAS manager 114 retrieves the data element at the storage location provided by CAS application 124 from content storage 112, calculates the content identifier for the retrieved data element using content identifier generator 116, and sends the retrieved data element and the newly-calculated content identifier to CAS application 124. In step 318, CAS application 124 compares the newly-calculated content identifier with the content identifier stored in preview-identifier storage 122.

In step 320, if the content identifiers match, the method continues with step 322, in which CAS application 124 creates a watermarked image of the data element. CAS application 124 converts the data element into a non-alterable image-based format, such as, for example, PDF or TIFF. CAS application 124 applies a watermark to the image of the data element. The watermark is a representation of the content identifier of the data element. In one embodiment, the watermark is a 26 character alphanumeric string derived from the content identifier; however any representation of the content identifier derived from the content identifier, and the content identifier itself, that is capable of being visually represented to a user and applied to an image is within the scope of the present invention. Examples of content identifier representations that may be used as watermarks are alphanumeric strings and graphical representations such as one-dimensional or two-dimensional barcodes.

Next, in step 324, CAS application 124 provides the watermarked image of the data element to CAS interface 132 at the requesting client 130. In step 326, CAS interface 132 displays the watermarked image of the data element to the user via the GUI. The watermarked image of the data element can be viewed, printed, copied to a removable media, or otherwise processed.

Returning to step 320, if the content identifiers do not match, the method continues with step 326, in which CAS application 124 reports the failure to retrieve the requested data element to CAS interface 132 of the requesting client 130.

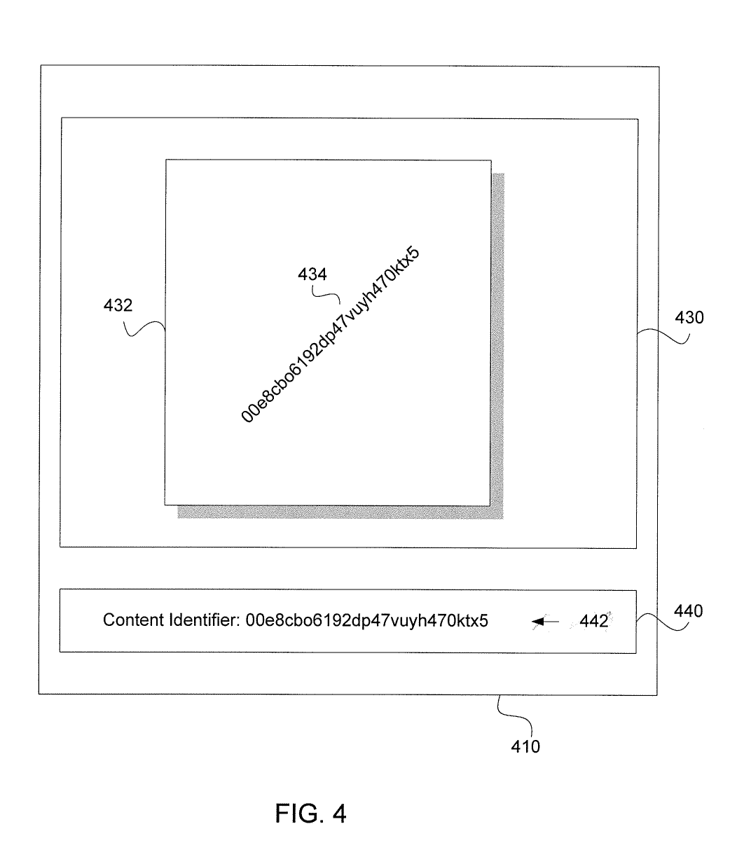

FIG. 4 is a diagram of one embodiment of a graphical user interface (GUI) 410, in accordance with the invention. GUI 410 is generated by CAS interface 132 to enable a user at client 130 to interact with CAS system 110. GUI 410 includes, but is not limited to, a viewing pane 430 and an identifier pane 440. Viewing pane 430 displays a watermarked image 432 of a data element retrieved from content storage 112. Watermarked image 432 includes a watermark 434 that is superimposed across the image. In the FIG. 4 embodiment, watermark 434 is a 26 character alphanumeric string derived from the content identifier. Identifier pane 440 displays a content identifier representation 442 for the data element corresponding to the watermarked image 432 currently shown in viewing pane 430. In the FIG. 4 embodiment, the content identifier representation 442 matches the watermark 434 of the watermarked image 432. In other embodiment, the content identifier representation 442 may have a different format than the watermark 434, although both the content identifier representation 442 and the watermark 434 are both derived from the content identifier of the data element.

By displaying both watermarked image 432 and content identifier representation 442, CAS interface 132 provides confirmation to the user that the content of the data element is authentic, i.e., that the retrieved data element is exactly the same as the data element that was stored in content storage 112. GUI 410 may also include a toolbar (not shown) that allows a user to print, copy, or otherwise process the watermarked image 432 of the retrieved data element. A printed copy of watermarked image 432 provides assurance, because of watermark 434, that the printed document is a true copy of the data element that was stored in content storage 112.

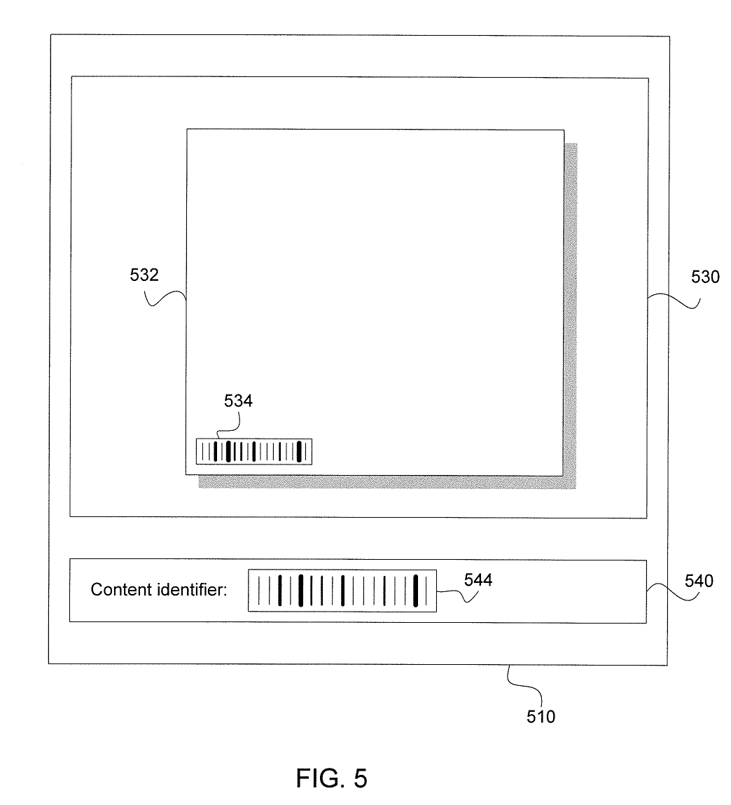

FIG. 5 is a diagram of another embodiment of a graphical user interface (GUI) 510, in accordance with the invention. GUI 510 is generated by CAS interface 132 to enable a user at client 130 to interact with CAS system 110. GUI 510 includes, but is not limited to, a viewing pane 530 and an identifier pane 540. Viewing pane 530 displays a watermarked image 532 of a data element retrieved from content storage 112. Watermarked image 532 includes a watermark 534 that is located in the lower left-hand margin area of the image. In the FIG. 5 embodiment, watermark 534 is a one-dimensional barcode derived from the content identifier. Identifier pane 540 displays a content identifier representation 544 for the data element corresponding to the watermarked image 532 currently shown in viewing pane 530. In the FIG. 5 embodiment, the content identifier representation 544 matches the watermark 534 of the watermarked image 532. In other embodiment, the content identifier representation 544 may have a different format than the watermark 534, although both the content identifier representation 544 and the watermark 534 are both derived from the content identifier of the data element.

By displaying both watermarked image 532 and content identifier representation 544, CAS interface 132 provides confirmation to the user that the content of the data element is authentic, i.e., that the retrieved data element is exactly the same as the data element that was stored in content storage 112. GUI 510 may also include a toolbar (not shown) that allows a user to view, print, copy, or otherwise process a data element. A printed copy of watermarked image 532 provides assurance, because of watermark 534, that the printed document is a true copy of the data element that was stored in content storage 112.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method comprising:
receiving a request to retrieve a data element;
determining a stored content identifier of the data element;
identifying a storage location in a storage device, the storage location associated with the stored content identifier;
retrieving a data element stored at the storage location;
calculating a second content identifier of the retrieved data element;
comparing the stored content identifier and the second content identifier; and
if the stored content identifier and the second content identifier match, creating a watermark derived from the stored content identifier, and creating an image of the retrieved data element that includes the watermark.

2. The method of claim 1, wherein calculating a second content identifier comprises applying a hashing algorithm to the content of the retrieved data element.

3. The method of claim 2, wherein the stored content identifier was generated using the hashing algorithm.

4. The method of claim 1, wherein the watermark is an alphanumeric string derived from the stored content identifier.

5. The method of claim 1, wherein the watermark is a graphical representation derived from the stored content identifier.

6. The method of claim 1, further comprising printing a copy of the image of the retrieved data element that includes the watermark.

7. A system comprising:
a content addressable storage manager configured to control the storing and retrieving of data elements to a content storage, the content addressable storage manager including a content identifier generator configured to produce a content identifier for each data element stored in the content storage;
a content addressable storage application coupled to the content addressable storage manager and configured to receive a retrieved data element and a stored content identifier for the retrieved data element from the content addressable storage manager, and configured to create a watermark derived from the stored content identifier and to create an image document of the data element that includes the watermark to produce a watermarked image; and
a content addressable storage interface configured to communicate with the content addressable storage application and to receive the watermarked image from the content addressable storage application.

8. The system of claim 7, wherein the content identifier generator applies a hashing algorithm to the content of a data element to produce a content identifier for the data element.

9. The system of claim 7, wherein the content identifier generator is further configured to calculate a second content identifier for a retrieved data element and the content addressable storage application is further configured to compare the second content identifier with the stored content identifier for the retrieved data element to confirm that the content of the retrieved data element is authentic.

10. The system of claim 9, wherein the content identifier generator is configured to apply a hashing algorithm to the content of the retrieved data element to calculate the second content identifier.

11. The system of claim 7, wherein the content addressable storage interface is configured to display the watermarked image to a user via a graphical user interface.

12. The system of claim 7, wherein the content addressable storage interface is configured to enable the watermarked image to be printed such that the watermark is visible on the printed watermarked image.

13. The system of claim 7, wherein content addressable storage interface is configured to enable the watermarked image to be stored on a removable storage medium.

14. The system of claim 7, wherein the watermark is a graphical representation derived from the stored content identifier.

15. A computer-readable medium storing instructions for causing a computer to perform:
receiving a request to retrieve a data element;
determining a stored content identifier of the data element;
identifying a storage location in a storage device, the storage location associated with the stored content identifier;
retrieving a data element stored at the storage location;
calculating a second content identifier of the retrieved data element;
comparing the stored content identifier and the second content identifier; and
if the stored content identifier and the second content identifier match, creating a watermark derived from the stored content identifier, and creating an image of the retrieved data element that includes the watermark.

16. The computer-readable medium of claim 15, wherein calculating a second content identifier comprises applying a hashing algorithm to the content of the retrieved data element.

17. The computer-readable medium of claim 16, wherein the stored content identifier was generated using the hashing algorithm.

18. The computer-readable medium of claim 15, wherein the watermark is an alphanumeric string derived from the stored content identifier.

19. The computer-readable medium of claim 15, wherein the watermark is a graphical representation derived from the stored content identifier.

20. The computer-readable medium of claim 15, further storing instructions for causing the computer to perform printing a copy of the image of the retrieved data element that includes the watermark such that the watermark is visible on the printed image.
